(19) United States
(12) Patent Application Publication
(10) Pub. No.: US 2017/0262793 A1
(43) Pub. Date: Sep. 14, 2017

(54) METHOD, SYSTEM, AND DEVICE FOR CONTROL OF BAILMENT INVENTORY

(71) Applicant: Chexology, LLC, Great Neck, NY (US)

(72) Inventors: Derek Pacque, New York, NY (US); Xitun Liu, Brooklyn, NY (US); Xu Zhang, New York, NY (US); Xiaoguang Zhu, Brooklyn, NY (US); Enhan Shi, New York, NY (US)

(73) Assignee: Chexology, LLC, Great Neck, NY (US)

(21) Appl. No.: 15/394,587

(22) Filed: Dec. 29, 2016

Related U.S. Application Data
(60) Provisional application No. 62/272,491, filed on Dec. 29, 2015.
(60) Provisional application No. 62/299,446, filed on Feb. 24, 2016.
(60) Provisional application No. 62/329,984, filed on Apr. 29, 2016.

(51) Int. Cl. G06Q 10/08; G06K 19/07; G06K 19/10; G06Q 20/32; G06K 7/10

(52) U.S. Cl. CPC G06Q 10/087; G06Q 20/3278; G06K 7/10861; G06K 19/10; G06K 19/0702

(57) ABSTRACT

Provided is a method for control of bailment inventory, comprising: a) receiving a customer identifier from a customer through pairing of a customer's electronic device and an electronic reader; b)communicating the identifier from the reader to a second electronic device; c) receiving from the customer at least one customer item for bailment; d) associating the customer identifier received in the second device with the at least one customer item; e) storing the at least one customer item; and f) returning the at least one customer item to the customer.

### CROSS REFERENCE

The present application claims the benefit of U.S. provisional application No. 62/272,491, filed on Dec. 29, 2015, U.S. provisional application No. 62/299,446, filed on Feb. 24, 2016 and U.S. provisional application No. 62/329,984, filed on Apr. 29, 2016, all of which are incorporated herein by reference in their entirety.

### BACKGROUND SECTION OF THE INVENTION

Bailment describes a legal relationship in common law where physical possession of personal property, or chattel, is transferred from one person (the bailor) to another person (the bailee) who subsequently has possession of the property. The disclosure herein relates to controlling inventory in any bailment situation, where one party is entrusting temporary custody of that party's personal property to another party for safekeeping. Bailment arises in a wide variety of situations, including valet parking, dry cleaning, warehousing and carriage of goods, to name just a few non-limiting examples.

It is known in the art to provide a service. either for a charge or gratuitously, whereby a person entering a business may check their coat'for safekeeping while they are on the premises of the business. The guest is generally given some form of token or ticket to identify which coat belongs to them, and the guest may retrieve the coat when they are ready to leave. Such services are popular because many guests do not want to bother with keeping track of their coat while they are on the premises. Providing a coat check attracts more customers to a business and enhances the customer experience while they are on the premises. While the concept of checking coats may seem straightforward, anyone running such a service quickly comes up against a number of well-known problems. Here are some, of the more persistent challenges:

The liability associated with checking coats is a large risk for a business providing a coat check. The expense of garment replacement, and the harm to the reputation of the business that come with losing a customer's coat, are potentially large. The expense of replacing a coat will often exceed the profit earned from the customer's visit by many multiples.

Traditional coat check services give customers a ticket or other token for their checked coat. It is not uncommon for customers, particularly those at bars or nightclubs, to then lose those tickets. This leads to customer frustration and longer check-out times while attempting to match the customer to their coat.

Coat check services in bars and nightclubs commonly wind up with a number of unclaimed coats at night's end. The establishment must then decide if they will deal with hanging on to the garments or trying to return them, or throw them out. Each answer presents its own set of drawbacks.

Customers do not want a coat checking process that slows them down unduly, and business owners do not want customers spending time at the coat check station when they could be making purchases. For some businesses, the crush of patrons all needing their coats at closing time also is a daunting prospect.

### SUMMARY SECTION OF THE INVENTION

Provided is a method for control of bailment inventory, comprising: a) receiving a customer identifier from a customer through pairing of a customer's electronic device and an electronic reader; b) communicating the identifier from the reader to a second electronic device; c) receiving from the customer at least one customer item for bailment; d) associating the customer identifier received in the second device with the at least one customer item; e) storing the at least one customer item (can include parking automobile in a valet situation); and f) returning the at least one customer item to the customer. The method can further comprise a step of automatically determining after receipt of the identifier whether the customer is checking-in or checking out, receiving payment information from the customer's electronic device, and/or processing the payment information with the second electronic device communicating the payment information to a third party. The pairing between the reader and the electronic device of the customer can be carried out in a wireless fashion. NFC (Near Field Communication) protocol can be used for the wireless communication. The communication between the reader and the second electronic device can be carried out in -a wireless fashion with Bluetooth. The reader can comprise a first processor configured to execute instructions for wireless communication with the customer's device, a general central processor, a rechargeable battery, and one of a plug jack for wired coupling with the second electronic device or a second wireless processor configured to execute instructions for wireless communication with the second electronic device. The electronic device <can further comprise a signal amplifier, an NFC booster, and a power management unit for controlling power of the battery. The step of associating the customer identifier with the at least one customer item can include scanning a tag or'a hanger with a unique code and the step of storing the customer item comprises storing the customer item with the hanger or the tag. The code can be communicated, with a NFC chip on the tag or the hanger. The NFC chip can be embedded in the tag. The tag can be read with the same reader that receives the customer's identifier. The second device can be a smart phone, a tablet computer, or a desktop computer configured to receive the identifier and process bailment.

Provided is a method for control of bailment inventory, comprising: a) receiving a customer identifier and payment information from a customer through pairing of a first electronic device of the customer and an, electronic reader through wireless communication with a first protocol; b) communicating the identifier and payment information from the reader to a second electronic device through wireless communication with a second protocol; c) receiving from the customer at, least one customer item for bailment; d) associating the customer identifier with the at least one customer item; e) storing the at least one customer item; and f) returning the at least one customer item to the customer; and g) communicating the payment information with a gateway to confirm the payment information. The first protocol can be configured to communicate at a shorter distance than the second protocol. The first protocol can be NEC and the second protocol can be Bluetooth. The method can further comprise the step of scanning a storage identifier with a chip operating under the second protocol and storing the at least one customer item with the storage identifier. The first protocol can be configured to communicate at a distance of less than 0.5 meters and the second protocol can be configured to communicate at a distance of less than 100 meters. The associating step can include taking a picture of the item. The steps of bailment (receiving, returning, storing) can be carried out by an attendant. The camera for taking a picture can be situated on an opposite side of the display. The picture of the item and the customer can be taken in a simultaneous fashion. No ticket can be issued to the customer for the bailment. The bailment item can be'a coat.

Provided is a method for control of bailment inventory, comprising: a) receiving a customer identifier from a customer through pairing of a customer's electronic device and an electronic reader; b) communicating the identifier from the reader to a second electronic device; c) receiving from the customer at least one customer item for bailment.

Provided is a system for control of bailment inventory, comprising: a) a reader configured for wireless communication with a first and, a second protocol, the first protocol configured to receive payment and identification information at a distance of less than 0.5 meters, and the second protocol configured to communicate the received payment and identification information to a second electronic device, the reader comprising a housing with a first processor to execute instructions for communication with the first protocol, a second processor to execute instructions for communication with the second protocol, a general processor, and a rechargeable battery; b) the second electronic device configured to receive the payment and identification information from the reader, the second device further configured to communicate the payment information to a gateway and to process the payment and identification information to check-in and check-out a customer in the bailment situation, the second electronic device comprising a processor to execute instructions for the second protocol, a general central processor, a rechargeable battery, and a touch screen. The system can further comprising a storage identifier configured to be stored with a bailment item, the storage identifier comprising a chip that can be scanned with the second electronic device through the second wireless protocol. The system has one or more programs, wherein the one or more programs, are stored in the memory and configured to be executed by the one or more processors, the one or more programs including instructions for the steps described above.

### BRIEF DESCRIPTION OF THE FIGURES

FIG. 1 illustrates the different components of a plug-in reader.

FIG. 2 illustrates the different components of a reader configured to communicate with Bluetooth.

FIG. 3 illustrates the check-in and check-out bailment process and payment processing.

FIG. 4 illustrates processing of payment with a system that uses an NFC reader.

FIG. 5 illustrates a payment reader and its compatibility with third party platforms.

FIG. 6 illustrates either a manual or an automatic selection of the check-in and check-out process.

FIG. 7 illustrates components of a tablet computer or a smart phone that is connected with the reader.

FIG. 8A illustrates coupling of reader with a jack plug to a tablet computer.

FIG. 8B illustrates front and back of a tablet computer.

FIG. 8C illustrates a standalone reader.

FIG. 9 illustrates a graphic user interface for entering a customer identification number during the check-in process.

FIG. 10 lustrates a graphic user interface depicting a picture of the bailor, customer identification (phone number), arid the picture of item.

FIG. 11 illustrates a graphic user interface for entering a customer identification number during the check-out process.

FIG. 12 illustrates a graphic user interface showing the picture of the customer, a customer identification (phone number), tag numbers. pictures of items, and the status of each item.

FIG. 13A illustrates a tag for attaching to a hanger having an embedded NFC chip.

FIG. 13B illustrates a tag with the embedded NFC chip placed on a hanger.

FIG. 14A illustrates a tag for attaching to a strap of a bag, having embedded NFC chip.

FIG. 14B illustrates a tag with the embedded NFC chip placed on a strap of a bag.

FIG. 15 illustrates various items for bailment.

### DETAILED DESCRIPTION OF THE INVENTION

Provided is an electronic device configured for contactless communication with another electronic device (such as a mobile/smart phone or watch). The communication can establish identity of the user and/or obtain authorization from the user and/or obtain payment information from the user. The communication can be used in a bailment situation to check-in/check-out bailors and/or to accept payment for bailment.

After contactless communication with a device of a user, the reader can send the information, such as payment and identification information, to the device/server of the person receiving the information, such as a payee/bailee. The payment or other information can be sent from the reader to the device of the payee via a wired communication, such as in case of a plug-in reader, or wirelessly, such as with Bluetooth. The identification information (identifier) can be one for example a name, a phone number, and/or a specific code associated with the person (an/or the person's device). The payment information can be a payment token, encrypted key, and/or other payment information (e.g., account number, account name) necessary to process a payment through a gateway in the cloud.

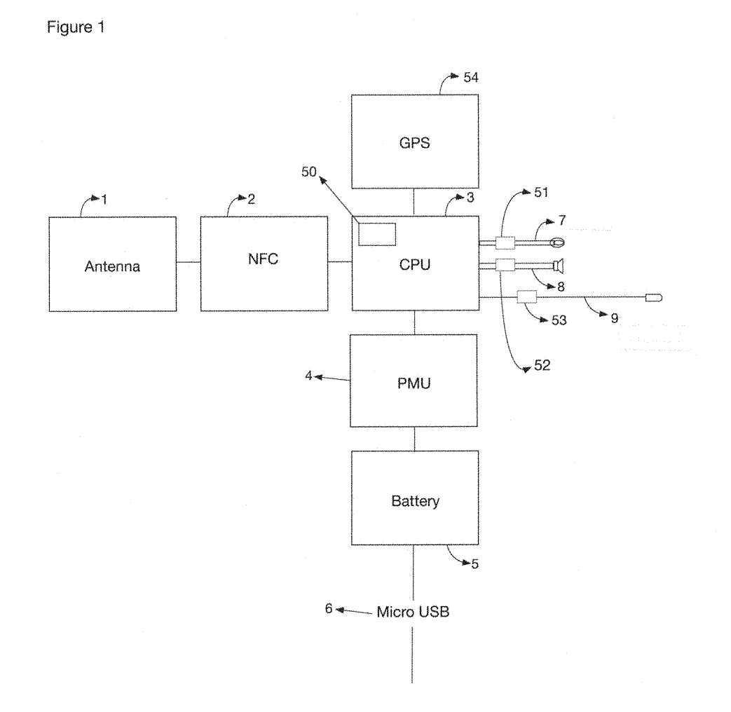

FIG. 1 illustrates components of a reader 100. In this case, the reader has a jack plug 9 that is designed to be plugged into another device, such as a smart phone or a tablet computer. A driver 53 can act as an interface arid facilitate electronic communication between the reader 100 and the device of a payee/bailee. The reader can be plugged into the audio port or other port on the electronic device. The reader can have an antenna 1 to communicate with a device of a user wirelessly (through NFC). Antenna 1 can contain a 13.56 MHz antenna, matching circuit and denoising circuit. All components can work together to receive NFC signal and send analog signal. The reader can have, an NFC chip 2, which can include a DSP (Digital Signal Processor) (such as NXP/Qualcomm NFC Chipset). The NFC chip 2 can demodulate analog signal to digital signal. The reader can have a CPU 3 (Central Processor Unit) for executing instructions of various programs. The CPU 3 can have internal/embedded memory 50. The reader can have a Power Management Unit (PMU) 4 for regulating power from rechargeable battery 5. The battery 5 can be a Lithium ion battery and can be coupled to a battery sensor which gives information, such as battery level. The reader can have a Micro-USB 6 or another port, which can be a female micro-USB port that is used to charge the battery 5. The reader can have one more lights, such as LEDs (Light Emitting Diodes) 7, for indicating the status of the reader. The LED 7 can provide different color light depending on the status of the reader. The reader can have a speaker 8. The speaker 8 can give information about state of scanning. The reader can have a plug jack 9. The plug jack 9 can be a standard 3.5 mm audio jack and audio signal selector, which makes it compatible, with different types of audio port. Drivers 51 and 52 can be used to allow the CPU to communicate with LED 7 and speaker 8 respectively.

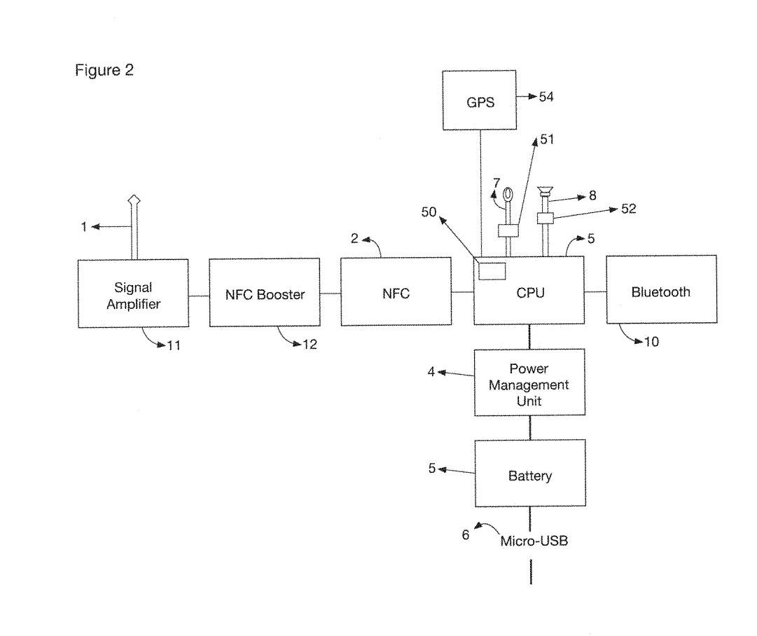

FIG. 2 illustrates components of a reader configured to communicate with a wireless protocol, such as Bluetooth. The reader can have an antenna 1. Antenna 1 can be a 13.56 MHz antenna with matching circuit and denoising circuit. All components can work together to receive and exchange signals. The reader can have an NFC chip 2 (NXP/Qualcomm NFC Chipset). The NFC chip 2 can be a signal processor, which demodulate analog signal to digital signal. The reader can have a CPU 3 (Central Processor Unit) for executing instructions of various programs. The CPU 3 can have internal/embedded memory 50. The reader can have a Power Management Unit (PMU) 4 for regulating power from battery 5. The battery 5 can be a Li-ion battery and can be coupled to a battery sensor which gives information, such as battery level. The reader can have a Micro-USB 6, which can be a female micro-USB port that is used to charge the battery. The reader can have one more lights, such as LEDs 7, for indicating the status of the reader. The LED 7 can provide different color light depending on the status of the reader. The reader can have a speaker 8. The speaker 8 can give information about state of scanning and receiving communication from a user. In addition this reader has can have a signal amplifier 11 that can enhance the signal to allow scanning at longer distances. NFC booster 12 can also filter the signal and makes it faster for the processor (CPU) to handle. The Bluetooth chip 10 can be used to communicate with the payee/bailee's electronic device which also has its own Bluetooth chip. The Bluetooth chip 10 can modulate the digital signal into analog signal again. Bluetooth Antenna can send the Bluetooth signal out. The Bluetooth antenna can be a double loop antenna. Drivers 51 and 52 can be used to allow the CPU to communicate with LED 7 and speaker 8 respectively.

Additional optional components for the reader include a GPS (Global Positioning System) chip 54 that informs the system where the reader is at time of communication. The reader can consist of, consist essentially of, or comprise of any of the above components.

The Bluetooth Reader (FIG. 1 or 2) can be a standalone for Desks/Walls, or for desktops. The Bluetooth Reader can have a clipping mechanism for handsets/tablets, and/or a universal stand. The reader can have an aluminum top casing (housing), and an exterior shell casing and volumetric measurements to fit a 300-400 mah lithium ion battery. The housing of the reader can be made of plastics, polymer, and rubber, iron/steel mix. The circuit board in the reader can be layered board or flat board. The charging port location layout of the reader can be flush, non-flush, or contact material. The reader can have a screen, such as an OLED screen used with the Linux operating system. The reader can have no buttons, or have 1, 2, 3 or a plurality of buttons. The LEDs on the reader can light up in a sequence, be a circle of LEDs, or be a 4 phase LED. The reader can have a logo placed on it. The status of the reader, for example as indicated by one or more of the LED lights or communicated to another electronic device, can be: I/O on-off, low battery. charging, updating bios/firmware, error, no interact connection, or payment fail. The reader can have a Bluetooth light. The reader can be activated by touch/force or touch/swipe. The reader can have an On/Off switch.

The reader can be configured to communicate with a smart phone, tablet computer, or other electronic devices configured to receive communication from the reader. The reader can work on any mainstream tablet, smart phone, and Bluetooth computer (Win 10, Surface Pro, OSX).

The reader can be used for B2B/B2C transactions. The reader can be used in a process for a unified, secure, and seamless check-in and check-out experience via contactless payments.

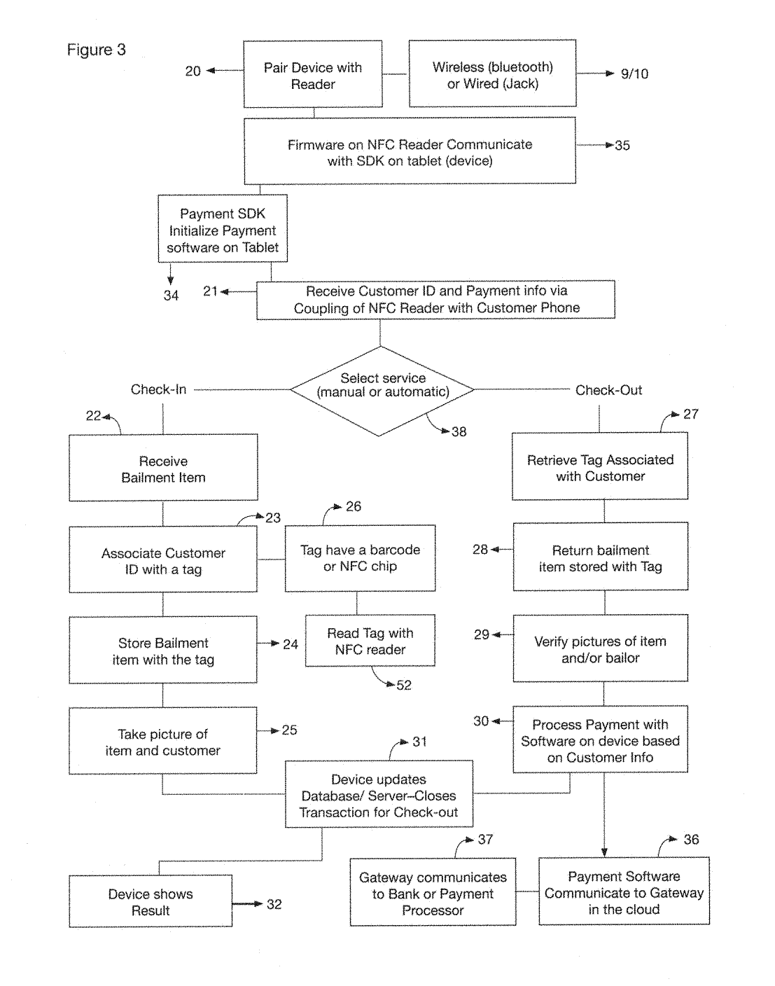

FIG. 3 illustrates a bailment and/or payment process. The process can include the bailee/payee having an electronic device 200 with a display that the bailee uses to track customers and items. The electronic device that the bailee 200 uses can be a tablet computer, a smartphone, a laptop or a desktop, with a display, and optionally a camera 203 on the side of the display, and/or a camera 203 on the opposite side of the display. The device can be paired with an NFC reader of a bailee 20, such as the NFC reader illustrated in FIGS. 1 and 2. The connection of the tablet computer to the NFC reader 33 can be wired (such as with a plug-in jack) 9 or wireless 10, such as with Bluetooth.

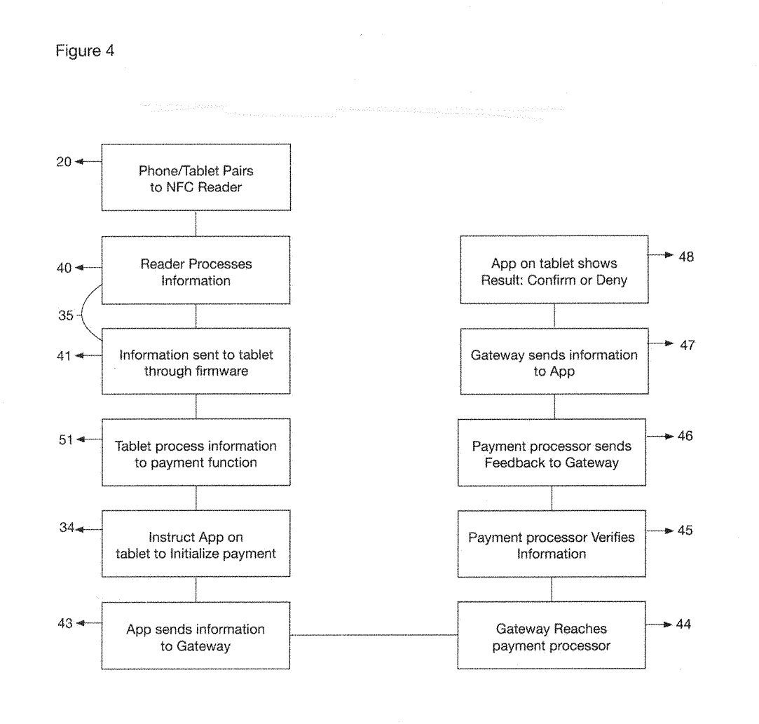

If the system is configured to accept payment, the NFC reader can receive payment information from the bailor. The firmware on the reader communicates with the SDK (Software Development Kit) on the electronic device of the bailee 35 to initialize the payment software (app) 34 on the device (e.g. tablet computer) of the bailee as shown in further detail in FIG. 4.

During the check-in and the check-out process, customer identification is obtained 21 in a touch-less/contactless manner by the customer bringing her or her smart phone or other electronic device having an NFC chip in proximity to the NFC reader (of FIG. 1 or 2) so that an electronic communication occurs (pairing) between the two devices. The check-in or check-out service is selected, either automatically or manually 38. The customer identification can be received directly through NFC communication, eliminating the need for the customer or the attendant to enter any additional identifying information. The customer identification can be a unique identification code that is communicated by the NFC chip on the customer's smart phone. An attendant obtains the bailment item from the customer 22. The bailment system can then associate the customer identification that is received with a tag that is stored with the customer item 23. The item's attributes can be stored in the system, for example, by taking a picture of the customer and the item simultaneously. The tag can have a machine readable barcode or an NFC chip, or other alternative means for identification 26. If the tag 400 has an NFC chip 401, the same NFC reader that is paired with the electronic device can be used to also read 52 the tag 400. The bailment system can take a picture of the bailment item and/or the customer 25. The Bailment item is stored with the tag 24. The bailment system allows for carrying out the bailment process quickly in a simultaneous manner. Once the NFC, reader is paired with the customer's phone 21, the system can take pictures of the items and/or customer 25 automatically.

During the check-out process, the customer again brings his or her smart phone in proximity to the NFC reader to pair 20 the devices for a second time. The system receives the customer identification 21. Based on the unique identification code present in the customer's NFC chip or other identifying information, the bailment system automatically recognizes the customer 38, and identifies the bailment item for the attendant. For example, the system may display the tag identification number for the attendant and/or make the tag light up or make a sound. The attendant then retrieves tag associated with the customer 27 and returns the bailment item 28. The attendant may also verify pictures of the item and/or bailor before handing out the item back to the bailor 29 The device of the payee (tablet computer or other electronic device like a smart phone) then processes payment information with software on the device based on payment information received through NFC coupling 30. The payment can be processed by payment software on the electronic device communicating to a payment gateway in the cloud 36 (internet). The gateway then communicates to a bank or a payment processor 37.

After completion of check-in or check-out/payment, the App on the payee's electronic device 31 updates the database/server, and closes the transaction in case of check-out 31. The App on the electronic device can then display the results 32, such as data about the cost of the transaction, and the time of check in and check out.

Alternative contactless communications can be carried out, including scanning of a barcode, such as a 2D barcode like a QR code, or entering of information on a screen by a customer. The system can allow for both contactless and touch communication, and leaving it to the customer to choose the desired alternative.

FIG. 4 illustrates processing of payment. The customer's portable electronic device (such as a smart phone or a wearable device like a watch) pairs with the NFC reader 20. After the pairing 20, the reader processes information 40 (NFC signal/data processing). The payment information is then sent from the firmware on the reader to the payee's electronic device (Steps 40 and 41 are same as 35), which processes the information to payment function 51. Software on the electronic device 41 instructs the payment application to initialize 34. The payment software then sends information via a communication network, such as the cloud 43, to the gateway in the cloud. The gateway then communicates with the payment processor 44. The payment processor verifies information 45 (such as name, account information, payment amount). The payment processor then sends feedback to the Gateway 46, and the Gateway communicates with the payment software and sends feedback to the software 47. The payment application software on the tablet computer (payee's electronic device) then displays the denial or acceptance of payment 48.

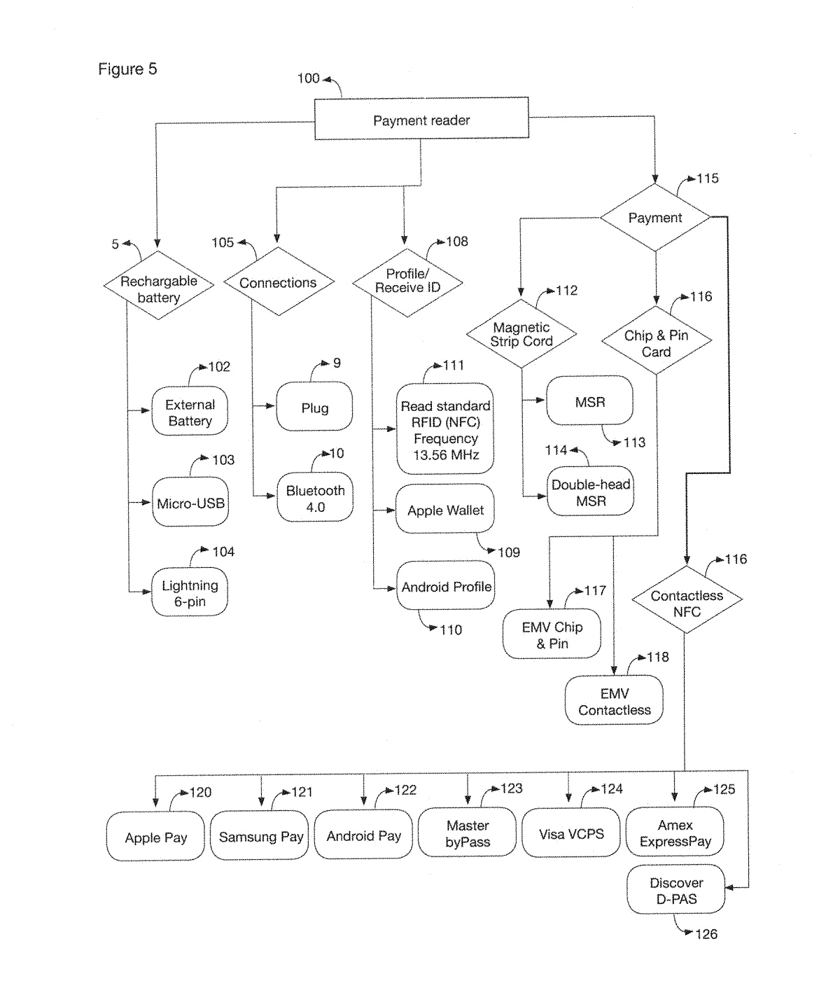

FIG. 5 illustrates various configurations of a payment reader 100. The reader 100, can have an NFC processor 111, and receive customer ID and customer profile through wireless communication, such as with a phone having an NFC processor. The profile can be retrieved from Apple Wallet® 109 and Android® profile 110 through NFC communication. The payment reader 100 can have a rechargeable battery 5 that can be charged by an external battery 102 by making a connection through Micro-USB 103 (same as 6) or lightning 6-pin 104. The payment reader 100 can make a wired connection through a jack 9, or wireless through Bluetooth 10, or other communication protocols. Payment 115 can be accepted through different methods. Payment can be read from a Magnetic Strip Card 112 with a Magnetic Strip Reader (MSR) (113,114). Payment 115 can be made with a chip & pin card 116, such as EMV (Europay®, MasterCard® and Visa®) chip & pin 117 or contactless EMV 118. Payment can be made through contactless NFC, such as Apple pay® 120, Samsung pay® 121, Android pay® 122, Master bypass®123, Visa® VCPS 124, Amex ExpressPay® 125, and Discover® DPAS 126.

The payment system can be used with a 4-step Security Flow: Tokenization, Secure Element, EMV protocol, Touch ID, or fingerprint. Commercial contactless standards to be supported can include Apple Wallet®, ApplePay®, Android Pay®, Samsung Pay®, Mastercard PayPass®, and Visa payWave®. The system also allows for Network-level Tokenization. For example Apple Pay has integrated with all gateways, processors, issuers, acquirers in current payment scheme by negotiating directly with Visa®, MasterCard®, AMEX®, BofA®, JPMorgan Chase®, Wells Fargo®.

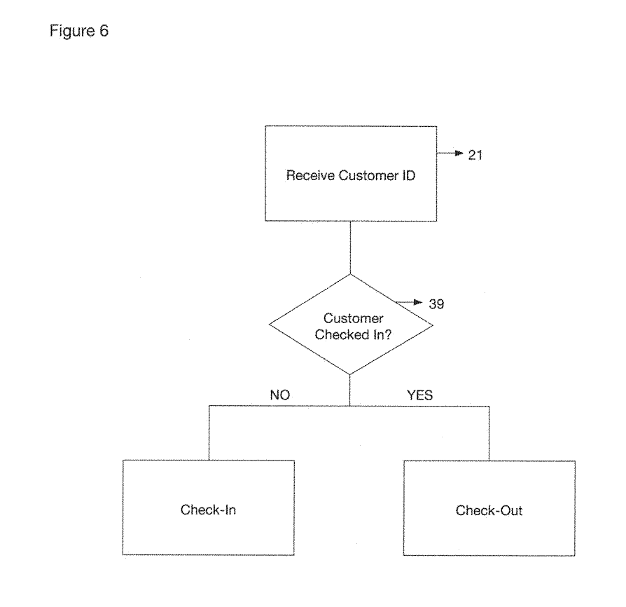

FIG. 6 illustrates either a manual or an automatic selection of the check-in and check-out process. Either the system can prompt, a user to select the check-in or the check-out process. Alternatively the system (tablet computer app) can determine if the user has previously be checked-in 39, and based on that determination select the check-in or the check-out process.

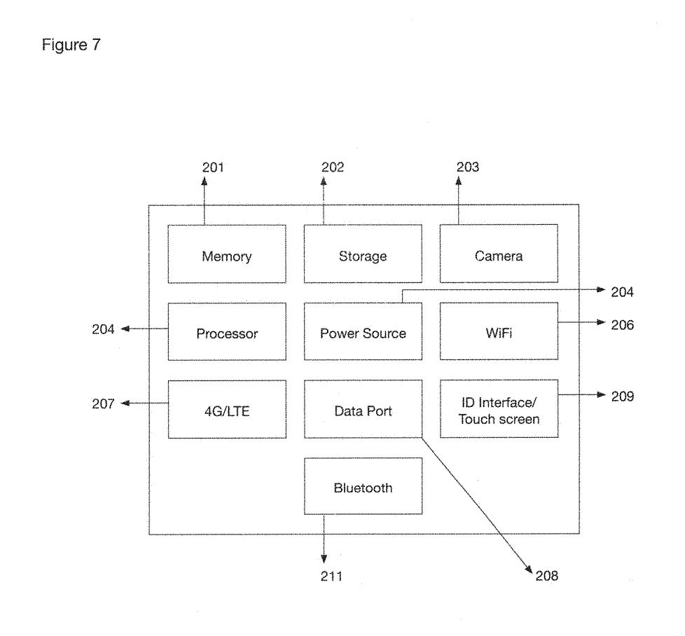

FIG. 7 illustrates components of a tablet computer or a smart phone or other electronic device of the bailee and/or the bailor. These components can be memory 201, storage 202, camera 203, processor 204, power source 205, WiFi 206 (for wireless communication with a router to connect to the cloud/internet), 4G/LTE 207 (for wireless communication with a tower to connect, to the cloud/Internet), data port 208, ID interface/touchscreen 209, and Bluetooth 211 (for wireless communication with another device).

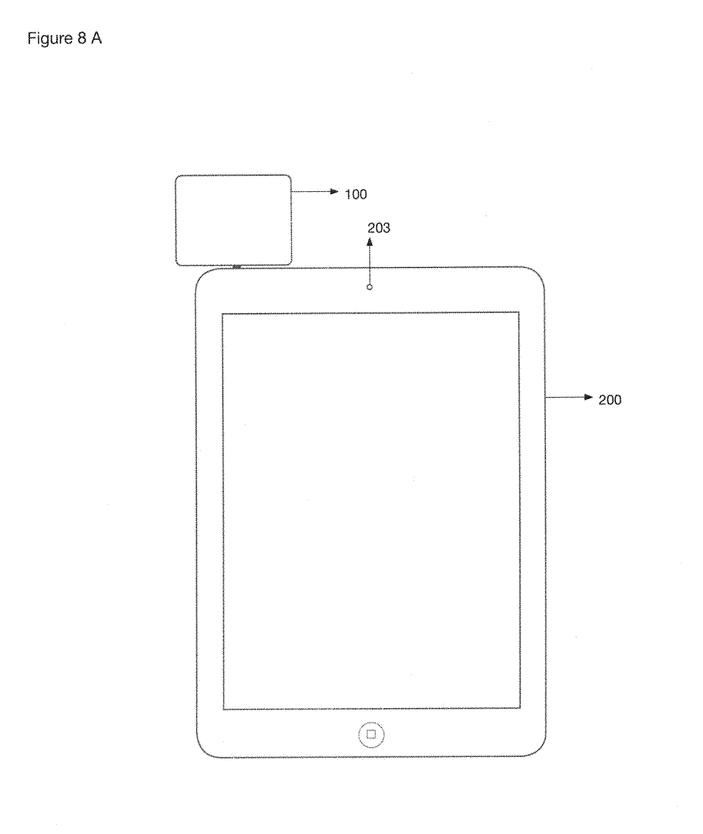

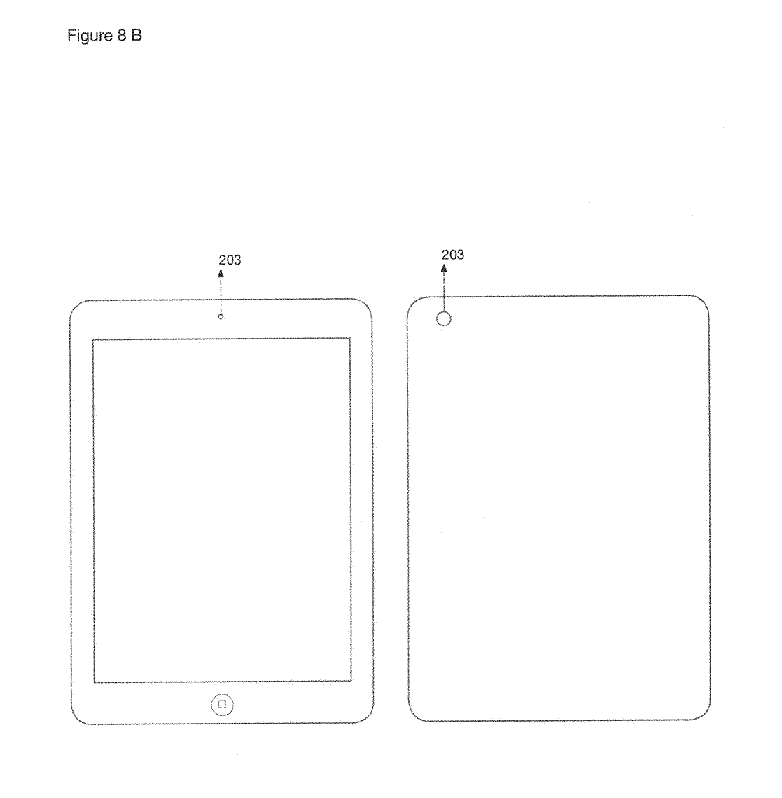

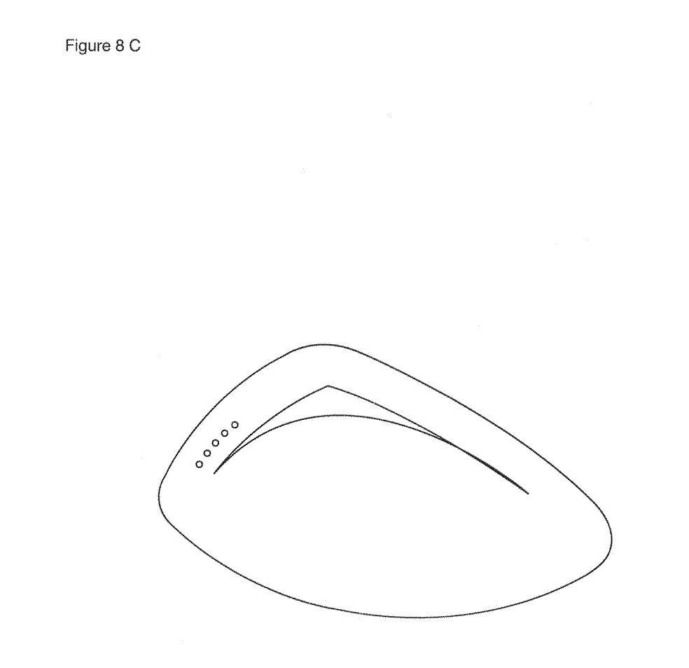

FIG. 8A illustrates wired connection of payee's electronic device, here >a tablet computer 200, with the reader 100. FIG. 8B illustrates a camera 203 on the front and back of the device 200 configured to take pictures of items/bailers/payors. FIG. 8C illustrates a standalone reader. The reader can be affixed to tablets/phones via Neodymium magnets.

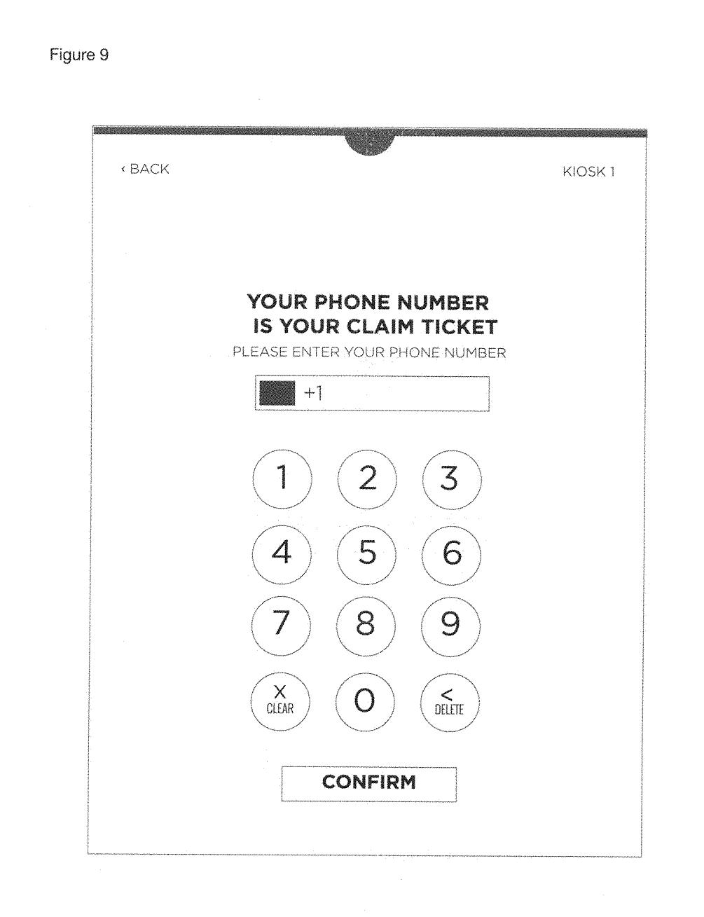

FIG. 9 illustrates receiving an input on a touch screen from a user, in this case a customer identifier in form of a phone number. The customer identifier can be used to create an account for the user and associate the account with the identifier received through NFC pairing. Alternatively, the customer can be given the option to check-in with wireless pairing (NFC), entering an identification number on a touch screen, or with biometrics (facial recognition, finger print).

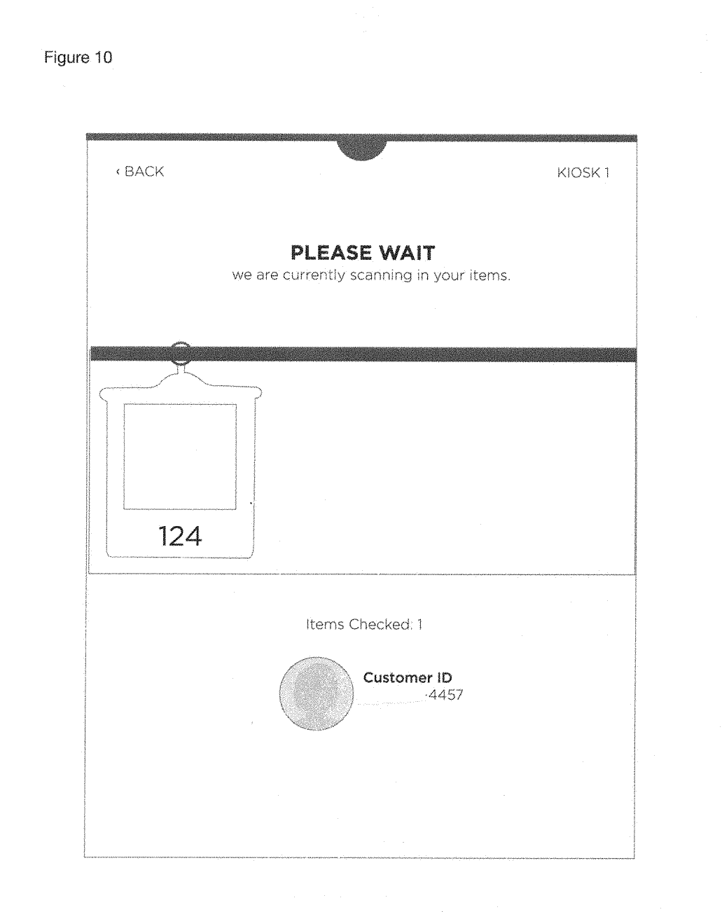

FIG. 10 illustrates another graphic user interface, where one item has been scanned. A picture of the item, a picture of the customer, and a customer identifier can be shown on a single page to an attendant and/or the customer.

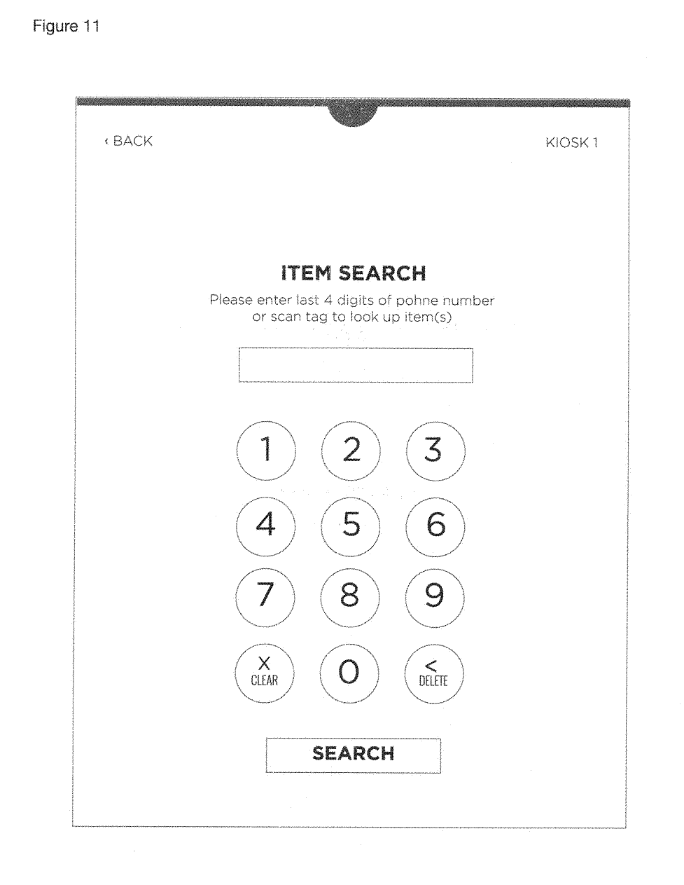

FIG. 11 illustrates searching for an item when a customer, returns to check out. The customer enters the identifier, in this case last four digits of a phone number to retrieve the account. Alternatively, the customer can scan a smartphone to check-in with NFC, or use biometrics to check-in.

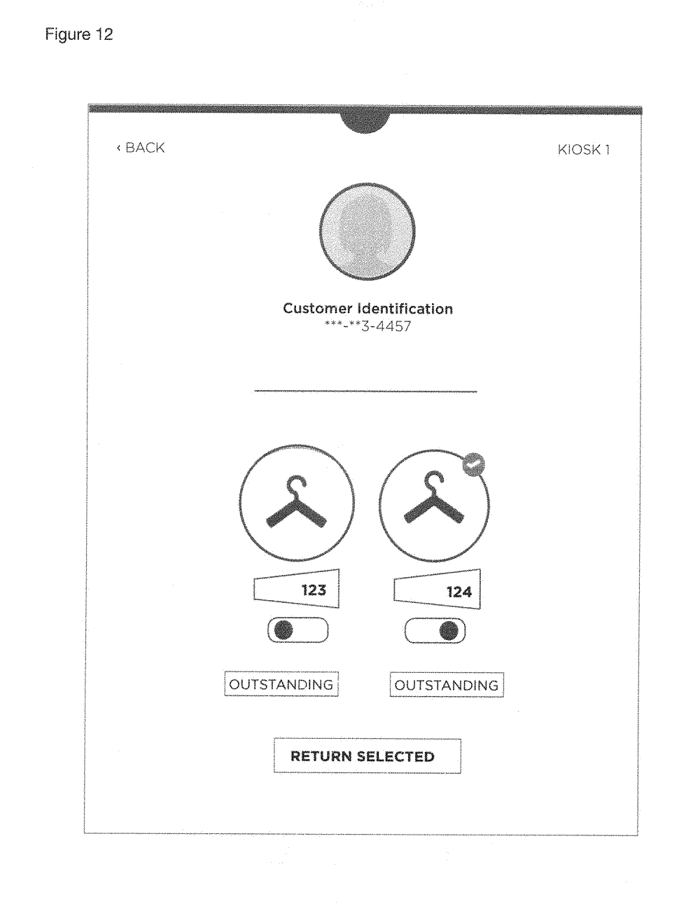

FIG. 12 illustrates another graphic user interface after which a customer has been identified during the check-out process. The interface shows the customer's picture, the customer's identifier (phone number), the customer's items (optionally their pictures), tag numbers, and which items are outstanding.

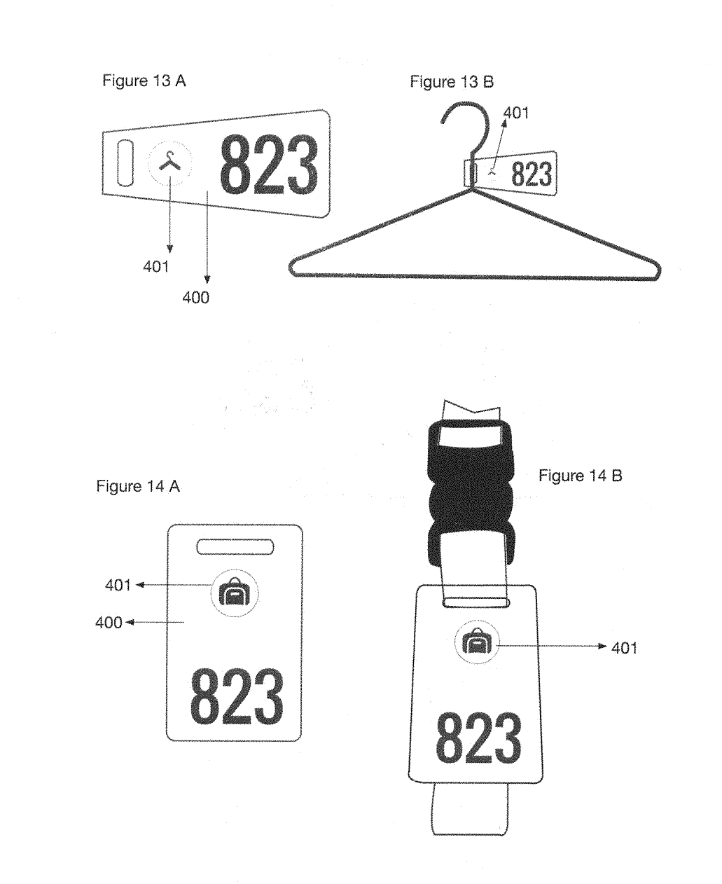

FIG. 13A illustrates a tag 400 for placing on a hanger. The tag 400 can have an identification number or a chip, in this case an embedded NFC chip 401 that can be scanned by the reader to verify that the check-out process is being carried out accurately. FIG. 13B illustrates the tag 400 of FIG. 13A on the hanger. The tag 400 of FIG. 14A is similar except that it has a larger opening that is configured to attach to the strap of a bag.

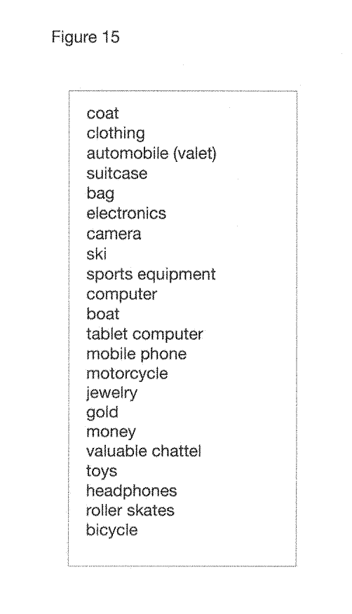

FIG. 15 illustrates various bailment items, including coat, clothing, automobile (valet), suitcase, bag, electronics, camera, ski, sports equipment, computer, boat, tablet computer, mobile phone, motorcycle, jewelry, gold, money, valuable chattel, toys. headphones, and roller skates.

The system can be used as a universal authentication system. For example, after a customer pairs its NFC configured device, the customer can log into third party websites like AirBnB®. By checking in, the customer is authenticated, and can carry transaction on third party websites.

Near-field communication (NFC) is a set of communication protocols that enable two electronic devices, one of which is usually a portable device such as a smartphone, to establish communication by bringing them within 4 cm (1.57 in) of each other. NFC standards cover communications protocols and data exchange formats and are based on existing radio-frequency identification (RFID) standards including ISO/IEC 14443 and FeliCa. The standards include ISO/IEC 18092 and those defined by the NFC Forum. In addition to the NFC Forum, the GSMA group defined a platform for the deployment of GSMA NFC Standards within mobile handsets. GSMA's efforts include Trusted Services Manager, Single Wire Protocol, testing/certification and secure element. The Bluetooth protocol RFCOMM is a simple set of transport protocols, made on top of the L2CAP protocol, providing emulated RS-232 serial ports (up to sixty simultaneous connections to a Bluetooth device at a time). The protocol is based on the ET8I standard TS 07.10.

U.S. Pat. Nos. 9,384,462 and 8,985,440 are incorporated herein by reference in their entirety for all their teaching of the bailment process.

What is claimed is:

1. A method for control of bailment inventory. comprising:
a) receiving a customer identifier from a customer through pairing of a customer's electronic device and an electronic reader;
b) communicating the identifier from the reader to a second electronic device;
c) receiving from the customer at least one customer item for bailment;
d) associating the customer identifier received in the second device with the at least one customer item;
e) storing the at least one customer item; and
f) returning the at least one customer item to the customer.

2. The method of claim 1, further comprising a step of automatically determining after receipt of the identifier whether the customer is checking-in or checking out.

3. The method of claim 1, further comprising receiving payment information from the customer's electronic device.

4. The method of claim 3, further comprising processing the payment information with the second electronic device communicating the payment information to a third party.

5. The method of claim 1, wherein the pairing between the reader and the electronic device of the customer is carried out in a wireless fashion.

6. The method of claim 5, wherein NFC (Near Field Communication) protocol is used for the wireless communication.

7. The method of claim 1, wherein the communication between the reader and the second electronic device is carried out in a wireless fashion with Bluetooth.

8. The method of claim 1, wherein the reader comprises a first processor configured to execute instructions for wireless communication with the customer's device, a general central processor, a rechargeable battery, and one of a plug jack for wired coupling with the second electronic device or a second wireless processor configured to execute instructions for wireless communication with the second electronic device.

9. The method of claim 8, wherein the electronic device further comprises a signal amplifier, an NFC booster, and a power management unit for controlling power of the battery.

10. The method of claim 1, wherein the step of associating the customer identifier with the at least one customer item includes scanning a tag or a hanger with a unique code and the step of storing the customer item comprises storing the customer item with the hanger or the tag.

11. The method of claim 10, wherein the code is communicated with a NFC chip on the tag or the hanger.

12. The method of claim 11, wherein the NFC chip is embedded in the tag.

13. The method of claim 11, wherein the tag is read with the same reader that receives the customer's identifier.

14. The method of claim 1, wherein the second device is a smart phone or a tablet computer configured to receive the identifier and process bailment.

15. A method for control of bailment inventory, comprising:
a) receiving a customer identifier and payment information from a customer through pairing of a first electronic device of the customer and an electronic reader through wireless communication with a first protocol;
b) communicating the identifier and payment information from the reader to a second electronic device through wireless communication with a second protocol;
c) receiving from the customer at least one customer item for bailment;
d) associating the customer identifier with the at least one customer item;
e) storing the at least one customer item; and
f) returning the at least one customer item to the customer; and
g) communicating the payment information with a gateway to confirm the payment information.

16. The method of claim 15, wherein the first protocol is configured to communicate at a shorter distance than the second protocol.

17. The method of claim 15, wherein the first protocol is NFC and the second protocol is Bluetooth.

18. The method of claim 15, further comprising, the step of scanning a storage identifier with a chip operating under the second protocol and storing the at least one customer item with the storage identifier.

19. A system for control of bailment inventory, comprising:
a) a reader configured for wireless communication with a first and a second protocol, the first protocol configured to receive payment and identification information at a distance of less than 0.5 meters, and the second protocol configured to communicate the received payment and identification information to a second electronic device, the reader comprising a housing with a first processor to execute instructions for communication with the first protocol, a second processor to execute instructions for communication with the second protocol, a general processor, and a rechargeable battery;
b) the second electronic device configured to receive the payment and identification information from the reader, the second device further configured to communicate the payment information to a gateway and to process the payment and identification information to check-in and check-out a customer in the bailment situation, the second electronic device comprising a processor to execute instructions for the second protocol, a general central processor, a rechargeable battery, and a touch screen.

20. The system of claim 19, the system further comprising a storage identifier configured to be stored with a bailment item, the storage identifier comprising a chip that can be scanned with the second electronic device through the second wireless protocol.
